(19) United States
(12) Patent Application Publication
(10) Pub. No.: US 2016/0259044 A1
(43) Pub. Date: Sep. 8, 2016

(54) THREE-DIMENSIONAL POSITIONING METHOD

(71) Applicant: National Central University, Taoyuan County (TW)

(72) Inventors: Liang-Chien Chen, Taoyuan County (TW); Chin-Jung Yang, Tainan City (TW)

(21) Appl. No.: 15/156,423

(22) Filed: May 17, 2016

Related U.S. Application Data
(63) Continuation-in-part of application No. 13/869,451, filed on Apr. 24, 2013.

(30) Foreign Application Priority Data
Jan. 4, 2013 (TW) 102100360

(51) Int. Cl. G01S 13/86; G06T 7/00; G01S 13/90

(52) U.S. Cl. CPC G01S 13/867; G01S 13/90; G06T 7/0046; B64G 2001/1028

(57) ABSTRACT

A three-dimensional positioning system includes establishing a geometric model for optical AND radar sensors, obtaining rational function conversion coefficients, refining the rational function model and positioning three-dimensional coordinates. The system calculates rational polynomial coefficients from a geometric model of optical AND radar sensors, followed by refining a rational function model by determined ground control points and object image space intersection. The system then measures one or more conjugate points on the optical and radar images. Finally, an observation equation is established by the rational function model to solve and display three-dimensional coordinates.

### RELATED APPLICATIONS

This application is a continuation-in-part of U.S. application Ser. No. 13/869,451 filed Apr. 24, 2013 entitled “Three-Dimensional Positioning Method” and claims the priority of Taiwanese application 102100360 filed Jan. 4, 2013.

### BACKGROUND OF THE INVENTION

1. Field of the Invention

Embodiments relate to a three-dimensional positioning system, more particularly to a three-dimensional positioning system applicable to multiple satellite images in a satellite positioning system. More particularly, a three-dimensional positioning system uses a rational function model (RFM) with integration of optical data and radar data.

2. Description of Related Art

Common information sources for surface stereo information from satellite images are acquired by using optical images OR radar images. For optical satellite images, the most common method is to use three-dimensional image pairs. For example, Gugan et al. have proposed accurate topographic mapping based on SPOT imagery (Gugan, D J and Dowman, I J, 1988. Accuracy and completeness of topographic mapping from SPOT imagery Photogrammetric Record, 12 (72), 787-796). One pair of conjugate image points are obtained from more than two overlapped shot image pairs, and further, a three-dimensional coordinate is obtained by light intersection. Leberl et al. disclose radar three-dimensional mapping technology and the application of SIR-B (Leberl, F W, Domik, G. Raggam J., and Kobrick M., 1986. Radar stereo mapping techniques and application to SIR-B. IEEE Transaction on Geosciences & Remote Sensing, 24 (4): 473-481) and multiple incidence angle SIR-B experiments above Argentina: three-dimensional radargrammetry Analysis (Leberl, F W, Domik, G., Raggam. J., Cimino, J., and Kobrick, M., 1986. Multiple incidence angle SIR-B experiment over Argentina: stereo-radargrammetric analysis. IEEE Transaction on Geosciences & Remote Sensing, 24 (4): 482-491). With the use of radar satellite imagery, according to stereo-radargrammetry, one pair of conjugate image points are obtained from more than two overlapped shot radar image pairs, and further, ground coordinates are obtained by distance intersection. In addition, surface three-dimensional information is obtained from radar images by Interferomertic Synthetic Aperture Radar (InSAR), such as radar interference technology taking advantage of multiple radar images as proposed by Zebker and Goldstein in 1986. It is confirmed that undulating terrain is estimated by the interferometry phase of no-load synthetic aperture radar with phase differences. Thereby, surface three-dimensional information is obtained.

In past research and applications, only a single type of sensor image is used as the source of acquiring the three-dimensional coordinates, e.g. optical OR radar image data. However, for optical images, weather disadvantageously affects whether the images can be used or not. Radar images, even though less affected by weather, still have a shortcoming of difficult to form the three-dimensional pairs or challenging radar interferometry conditions.

In processing images, the prior art separately, not integrally, processes optical images OR radar images. Therefore, the prior art cannot meet the needs of users in actual use of integrating optical images AND radar images for three-dimensional positioning.

### SUMMARY OF THE INVENTION

Embodiments provide a three-dimensional positioning system with integration of radar AND optical satellite images and effectively improves the shortcomings of the prior art. Directional information in optical images and distance information in radar images are used to integrate geometric characteristics indicated by the optical images and the radar images in order to achieve three-dimensional positioning and to display the same.

Embodiments provide a three-dimensional positioning system using a standardized rational function model as a basis, which allows application to various satellite images. Furthermore, by a unified solution, more sensor data is integrated with good positioning performance to extend to the satellite positioning system.

One embodiment is directed towards a three-dimensional positioning system comprising:

a communication module configured to receive optical image data of a target area from one or more optical imagers and radar image data of the target area from one or more radar imagers;

a processor in communication with the communication module;

a display in communication with the processor; and

computer readable storage media in communication with the processor and configured to induce the processor to

(A) receive optical image data of the target area from the one or more optical imagers and to generate a plurality of corresponding optical images;

(B) employ direct geo-referencing to establish a first geometric model of the plurality of optical images;

(C) receive radar image data of the target area from the one or more radar imagers to generate a plurality of corresponding radar images;

(D) determine range data from the plurality of radar images and employ the range data and a Doppler equation to establish a second geometric model of the radar images;

(E) back project the plurality of optical images according to virtual ground control points in the first geometric model for the optical images;

(F) calculate optical image coordinates corresponding to the virtual ground control points using collinear conditions;

(G) back project the radar images according to the virtual ground control points in the second geometric model of the radar images;

(H) calculate radar image coordinates corresponding to the virtual ground control points with the range data and the Doppler equation;

(I) calculate rational polynomial coefficients for the optical images and for the radar images to establish an integrated rational function model;

(J) convert the optical and the radar image coordinates to a rational function space and calculate corresponding rational function space coordinates;

(K) obtain affine conversion coefficients from the rational function space coordinates and the optical and the radar image coordinates according to the ground control points;

(L) complete a linear conversion to correct system error;

(M) execute partial compensation via least squares collocation for amendments to eliminate systematic errors;

(N) measure conjugate points after the rational function model is established and refined from the optical images and from the radar images;

(O) place the conjugate points into the rational function model to establish an observation equation of three-dimensional positioning; and

(P) induce the display to display a position of a target within the target area as a three-dimensional spatial coordinate via a least squares method.

Another embodiment is directed to computer readable storage media configured to induce a processor and associated display to

(A) receive optical image data of the target area from the one or more optical imagers and to generate a plurality of corresponding optical images;

(B) employ direct geo-referencing to establish a first geometric model of the plurality of optical images;

(C) receive radar image data of the target area from the one or more radar imagers to generate a plurality of corresponding radar images;

(D) determine range data from the plurality of radar images and employ the range data and a Doppler equation to establish a second geometric model of the radar images;

(E) back project the plurality of optical images according to virtual ground control points in the first geometric model for the optical images;

(F) calculate optical image coordinates corresponding to the virtual ground control points using collinear conditions;

(G) back project the radar images according to the virtual ground control points in the second geometric model of the radar images;

(H) calculate radar image coordinates corresponding to the virtual ground control points with the range data and the Doppler equation;

(I) calculate rational polynomial coefficients for the optical images and for the radar images to establish an integrated rational function model;

(J) convert the optical and the radar image coordinates to a rational function space and calculate corresponding rational function space coordinates;

(K) obtain affine conversion coefficients from the rational function space coordinates and the optical and the radar image coordinates according to the ground control points;

(L) complete a linear conversion to correct system error;

(M) execute partial compensation via least squares collocation for amendments to eliminate systematic errors;

(N) measure conjugate points after the rational function model is established and refined from the optical images and from the radar images;

(O) place the conjugate points into the rational function model to establish an observation equation of three-dimensional positioning; and

(P) induce the display to display a position of a target within the target area as a three-dimensional spatial coordinate via a least squares method.

### BRIEF DESCRIPTION OF THE DRAWINGS

FIG. 1 is a flow chart of three-dimensional positioning by integrating radar and optical satellite imagery.

FIG. 2A is a diagram of ALOS/PRISM test images according to one embodiment.

FIG. 2B is a diagram of SPOT-5 test images according to one embodiment.

FIG. 2C is a diagram of SPOT-5 Super Mode test images according to one embodiment.

FIG. 2D is a diagram of ALOS/PALSAR test images according to one embodiment.

FIG. 2E is a diagram of COSMO-SkyMed test images according to one embodiment.

FIG. 3 is a block diagram of a three-dimensional positioning system employing optical AND radar image data.

FIG. 4 is a schematic example display of three-dimensional position data provided by embodiments of a three-dimensional positioning system employing optical AND radar image data.

### DETAILED DESCRIPTION OF THE PREFERRED EMBODIMENTS

The aforementioned illustrations and following detailed description are exemplary for the purpose of further explaining certain embodiments. It should be understood that the figures are schematic in nature and should not be understood as being to scale or illustrating exactly a particular implementation of aspects of embodiments. Other objectives and advantages will be illustrated in the subsequent descriptions and appended tables.

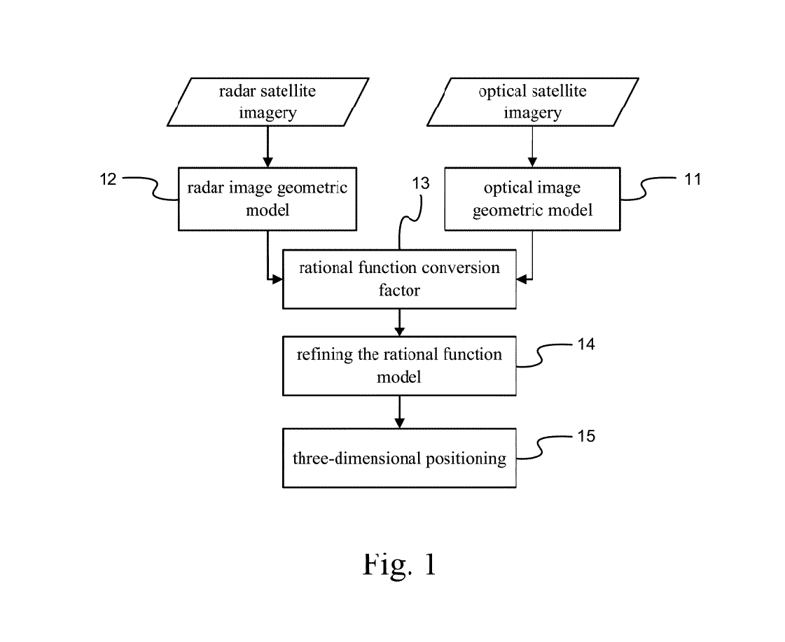

Surface three-dimensional information is essential to environmental monitoring and conservation of soil and water resources. Synthetic aperture radar (SAR) and optical imaging offer telemetry data useful for obtaining three-dimensional information. Integration of information from both optical AND radar sensors provides even more useful information. Please refer to FIG. 1 which is a flow chart of three-dimensional positioning by integrating radar AND optical satellite imagery according to one embodiment. FIG. 1 shows three-dimensional positioning by integration of radar AND optical satellite imagery. From the viewpoint of geometry, data of two or more heterogeneous sensors (e.g. optical data AND radar data) is combined to obtain three-dimensional information at a conjugate imaging point or area. A prerequisite for three-dimensional positioning measurement using satellite imagery is to establish a geometric model for linking the images with the ground. A rational function model (RFM) has the advantages of standardizing geometric models for facilitating description of the mathematical relationship between the images with the ground. Therefore embodiments employ a rational function model to integrate optical AND radar data for three-dimensional positioning.

In one embodiment, three-dimensional positioning includes at least the following steps:

(A) establishing an optical image geometric model 11: Direct georeferencing is used as a basis to establish a geometric model of optical images;

(B) establishing a radar image geometric model 12: A geometric model of radar images is established based on a Range-Doppler equation;

(C) obtaining a rational polynomial coefficients 13: Based on a rational function model, optical satellite images are subject to back projection according to virtual ground control points in a geometric model for optical images. An image coordinate corresponding to the virtual ground control points is obtained using collinear conditions. From the geometric model for the radar images, radar satellite images are subject to back projection according to the virtual ground control points. According to the distance and the Doppler equation, obtain an image coordinate corresponding to the virtual ground control points. Thereafter, rational polynomial coefficients for the optical images and the radar images are generated to establish a rational function model.

(D) refining the rational function model 14: In the rational function model, the image coordinate is converted to a rational function space and calculated as a rational function space coordinate. Then, the rational function space coordinate and the image coordinate according to the ground control points are used to obtain affine transformation coefficients. After the completion of linear conversion, system error correction is finished. By means of least square collocation, partial compensation is executed for amendments so as to eliminate systematic errors; and

(E) three-dimensional positioning 15: After the rational function model is established and refined, conjugate points are measured from the optical images and radar images. Those conjugate points are put into the rational function model to establish an observing equation of three-dimensional positioning. Positioning a target at a three-dimensional spatial coordinate is finished by a least square method.

At the above step (A), optical image geometric model is established using a direct geographic counterpoint method with a mathematical formula as follows:

\vec{G}=\vec{P}+S\vec{U},

Xᵢ=X(tᵢ)+Sᵢuᵢ^{X}

Yᵢ=Y(tᵢ)+Sᵢuᵢ^{Y}

Zᵢ=Z(tᵢ)+Sᵢuᵢ^{Z}

wherein, \vec{G} is a vector from Earth centroid to the ground surface; \vec{P} is a vector from Earth centroid to a satellite; Xᵢ, Yᵢ, Zᵢ are respectively ground three-dimensional coordinates; X(tᵢ), Y(tᵢ), Z(tᵢ) are satellite orbital positions; uᵢ^{X}, uᵢ^{Y}, uᵢ^{Z} are respectively image observation vectors; Sᵢ is the amount of scale; and tᵢ is time.

At the above step (B), the geometric model of the radar images based on the radar distance and Doppler equation has the mathematical formula as follows:

$$\vec{R} = \vec{G} - \vec{P} , \\ \vert \vec{R} \vert = \vert \vec{G} - \vec{P} \vert , \\ {f}_{d} = - \frac{2}{λ} \frac{d \vec{R}}{d t} ,$$

wherein \vec{R} is a vector from the satellite to a ground point; \vec{G} is a vector from the Earth centroid to a ground point of the vector; and \vec{P} is a vector from the Earth centroid to a satellite.

The rational function model at the above step (C) is obtained by getting rational polynomial coefficients according to a large number of virtual ground control points and the least square method, based on the rational function model. The mathematical formula is as follows:

$${S}_{RFM} = \frac{{p}_{a} ( X , Y , Z )}{{p}_{b} ( X , Y , Z )} = \frac{{\sum }_{i = 0}^{i = 3} {\sum }_{j = 0}^{j = 3} {\sum }_{k = 0}^{k = 3} {a}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {b}_{ijk} {X}^{i} {Y}^{j} {Z}^{k}}$$

$${L}_{RFM} = \frac{{p}_{c} ( X , Y , Z )}{{p}_{d} ( X , Y , Z )} = \frac{{\sum }_{i = 0}^{i = 3} {\sum }_{j = 0}^{j = 3} {\sum }_{k = 0}^{k = 3} {c}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {d}_{ijk} {X}^{i} {Y}^{j} {Z}^{k}} ,$$

wherein aᵢⱼₖ, bᵢⱼₖ, cᵢⱼₖ and dᵢⱼₖ are respectively rational polynomial coefficients.

At the above step (D), the rational function model is refined by correcting the rational function model via affine transformation. The mathematical formula is as follows:

Ŝ=A₀×S_{RFM}+A₁×L_{RFM}+A₂

\hat{L}=A₃×S_{RFM}+A₄×L_{RFM}+A₅

wherein Ŝ and \hat{L} are respectively corrected image coordinates; and A_{0˜5} are affine conversion coefficients.

At the above step (E), the observation equation of the three-dimensional positioning has mathematical formula as follows:

$$[ \begin{matrix}{υ}_{S}^{1} \\ {υ}_{L}^{1} \\ {υ}_{S}^{2} \\ {υ}_{L}^{2}\end{matrix} ] = [ \begin{matrix}\frac{\partial {S}_{1}}{\partial X} & \frac{\partial {S}_{1}}{\partial Y} & \frac{\partial {S}_{1}}{\partial Z} \\ \frac{\partial {L}_{1}}{\partial X} & \frac{\partial {L}_{1}}{\partial Y} & \frac{\partial {L}_{1}}{\partial Z} \\ \frac{\partial {S}_{2}}{\partial X} & \frac{\partial {S}_{2}}{\partial Y} & \frac{\partial {S}_{2}}{\partial Z} \\ \frac{\partial {L}_{2}}{\partial X} & \frac{\partial {L}_{2}}{\partial Y} & \frac{\partial {L}_{2}}{\partial Z}\end{matrix} ] [ \begin{matrix}dX \\ dY \\ dZ\end{matrix} ] + [ \begin{matrix}{\hat{S}}_{1} - {S}_{1} \\ {\hat{L}}_{1} - {L}_{1} \\ {\hat{S}}_{2} - {S}_{2} \\ {\hat{L}}_{2} - {L}_{2}\end{matrix} ] .$$

Thereby, a three-dimensional positioning system with integration of a radar AND optical satellite imagery is achieved.

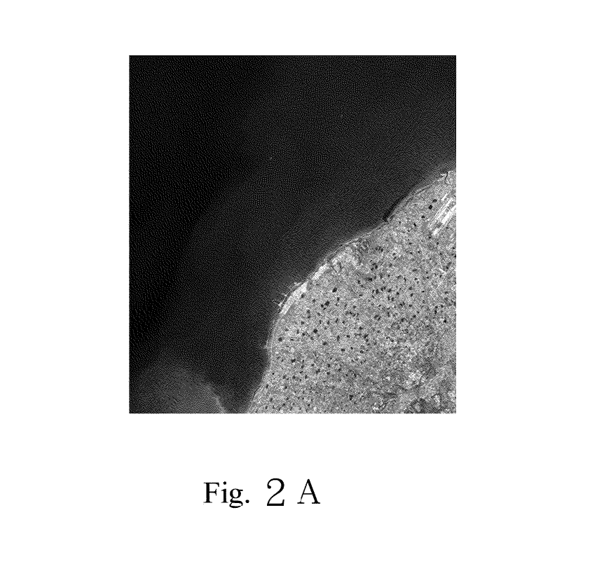

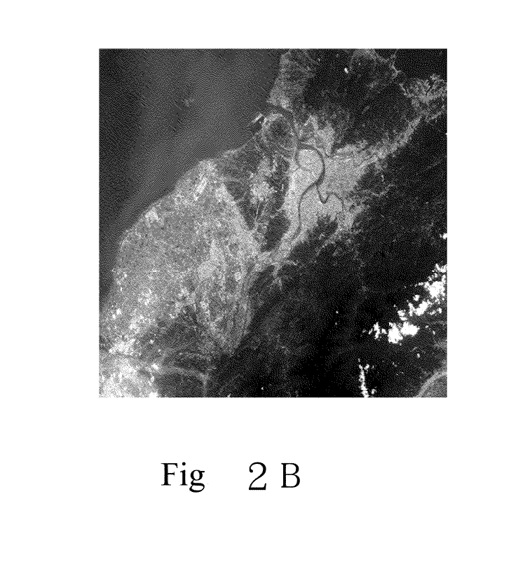

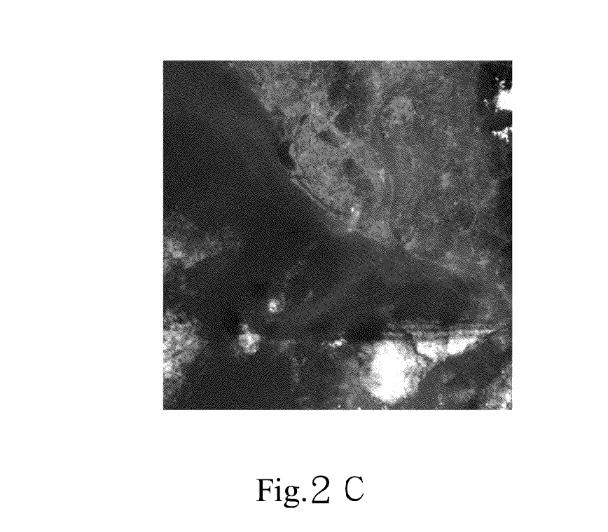

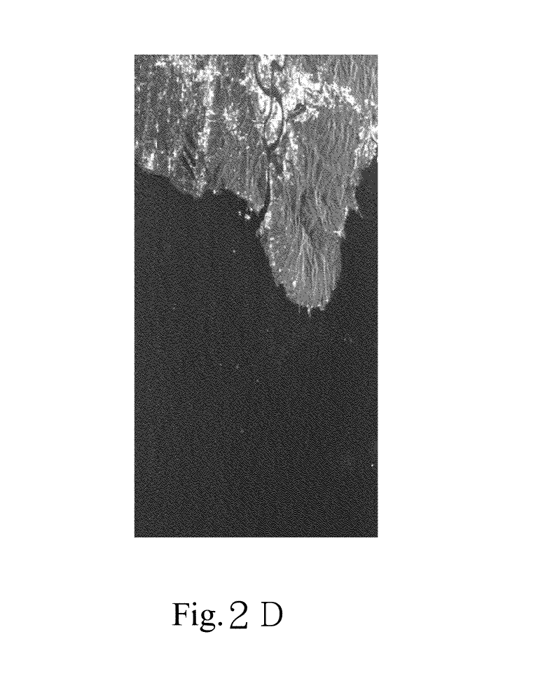

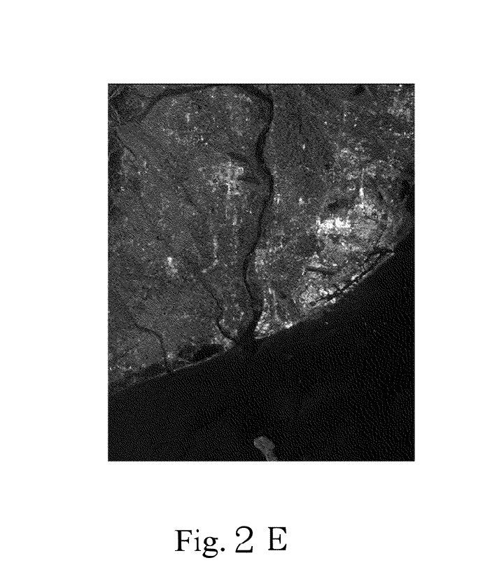

Please refer to FIG. 2A-FIG. 2E. FIG. 2A is a diagram of ALOS/PRISM source test images according to one embodiment. FIG. 2B is a diagram of SPOT-5 source test images. FIG. 2C is a diagram of SPOT-5 Super Mode source test images according to one embodiment. FIG. 2D is a diagram of ALOS/PALSAR source test images according to one embodiment. FIG. 2E is a diagram of COSMO-SkyMed source test images according to one embodiment. An embodiment uses test images containing two radar satellite images from the ALOS/PALSAR and COSMO-SkyMed imager sources, and three optical satellite images from the ALOS/PRISM, SPOT-5 panchromatic images and SPOT-5 Super mode imager sources for positioning error analysis, as shown in FIG. 2A-FIG. 2E.

Results of positioning error analysis are shown in Table 1. From Table 1 it is seen that integration of radar AND optical satellite achieves three-dimensional positioning of various accuracies, with the combination of SPOT-5 and COSMO-SkyMed achieving three-dimensional positioning with accuracy of about 5 meters.

TABLE 1

| | | north-south | |
|---|---|---|---|
| | East-west direction | direction | elevation |
| ALOS/PALSAR | 3.98 | 4.36 | 13.21 |
| ALOS/PRISM | | | |
| ALOS/PALSAR | 9.14 | 4.91 | 13.74 |
| SPOT-5 | | | |
| panchromatic | | | |
| image | | | |
| COSMO-SkyMed | 4.11 | 3.54 | 5.11 |
| SPOT-5 Super | | | |
| Resolution mode | | | |
| image | | | |

Unit: m

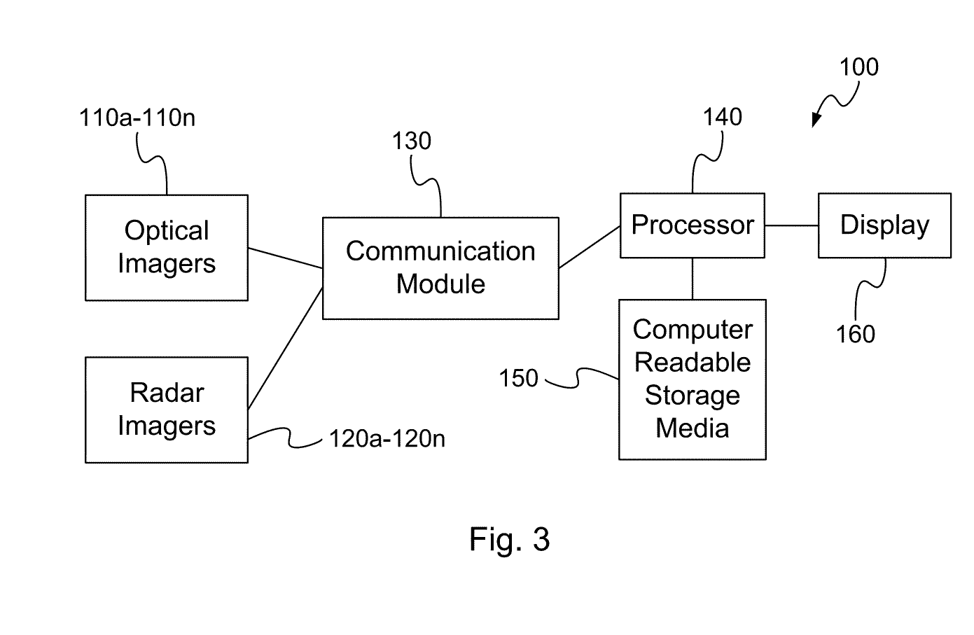

FIG. 3 is a schematic block diagram of a three-dimensional positioning system 100. The system 100 obtains optical data from one or more optical imagers 110a-110n, which can include satellite, ground, sea, and/or aerial platform based imagers. The system 100 also obtains radar data from one or more radar imagers 120a-120n, which can also include satellite, ground, sea, and/or aerial platform based imagers. It will be understood that the above recited imagers or sources 110a-110n, 120a-120n are simply an exemplary set of multiple imagers or sources capable of providing optical and/or radar image data. It will be understood that in various embodiments, the optical imagers 110a-110n and radar imagers 120a-120n are configured to operate at one or more wavelengths/frequencies appropriate to the requirements of particular applications. It will further be understood that a given device or different devices can be capable of providing optical and/or radar image data in multiple formats, resolutions, and spectra and that this aspect is referred to herein as different types of imagers or image data.

The system 100 also includes a communication module 130 configured to receive image data from the optical imagers 110a-110n and the radar imagers 120a-120n. The system 100 also includes a processor 140 in communication with the communication module 130 and with computer readable storage media 150. The processor 140 is configured to receive optical and radar image data from the optical imagers 110a-110n and the radar imagers 120a-120n. The processor 140 is further configured to execute instructions or software stored on the computer readable storage media 150, for example so as to execute the above described processes. The system 100 further comprises a display 160 configured to display visual images, which can include both graphical and alpha-numeric images. In one embodiment, the system 100 and display 160 are configured to display a two-dimensional representation of a three-dimensional target area and three-dimensional coordinates of a target point within the target area as calculated by the system 100.

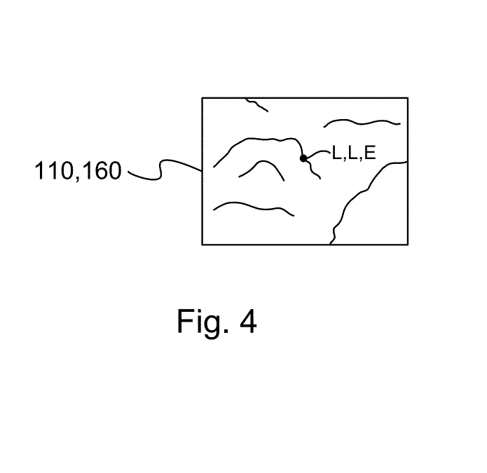

FIG. 4 illustrates an exemplary schematic image of information displayed by the system 100 via the display 160. Other physical components of the system 100 are not shown in FIG. 4 for ease of understanding. As shown in FIG. 4, the system 100 and display 160 present or display a visual two-dimensional representation of a three-dimensional target area, in this embodiment illustrated in a representative perspective view with contour lines. The system 100 calculates three-dimensional coordinates, e.g. a latitude, longitude, and altitude or elevation (L, L, E) for a selected target point within the target area. The system 100 presents the calculated three-dimensional position in a coordinate system and dimensional units appropriate to the requirements of a particular application.

The system 100 executes processing steps including establishing the geometric model of optical and radar imagers, obtaining rational polynomial coefficients, refining the rational function model and calculating and displaying three-dimensional position coordinates. Most of the radar and optical satellites only provide satellite ephemeris data, rather than a rational function model. Therefore, embodiments obtain rational polynomial coefficients from a geometric model of optical and radar images, followed by refining the rational function model by ground control points, so that object image space intersection is more accurate. The system 100 then measures the conjugate point of the optical AND radar images. Finally, the observation equation is established by the rational function model to solve the three-dimensional coordinates for presentation on the display 160.

Compared to traditional technology, embodiments have the following advantages and features.

First, in order to unify the solution of the mathematical model, both the optical and radar heterogenic images are applied to the same calculation method.

Secondly, both optical AND radar images are used to obtain the three-dimensional coordinates which is more compatible to various imagers and obtaining the coordinates, enhancing the opportunity for the three-dimensional positioning.

Finally, embodiments provide a universal solution, using the standardized rational function model for integration, regardless of homogeneity or heterogeneity of the images. All images can be used with this system 100 for three-dimensional positioning.

In summary, embodiments include a three-dimensional positioning system 100 with the integration of radar AND optical satellite images, which effectively improves the shortcomings of the prior art. The directional information in the optical images and the distance information in the radar images are used to integrate the geometric characteristics of the optical images AND the radar images in order to achieve the three-dimensional positioning. Unlike the prior art, embodiments use not only combinations of optical AND radar images, but also uses the standardized rational function model as basis, which allows application to various optical and radar imagers 110a-110n, 120a-120n. Furthermore, by a unified solution, more sensor data is integrated with good positioning performance to extend to a positioning system, and thus be more progressive and more practical in use which complies with the patent law.

The descriptions illustrated supra set forth simply the preferred embodiments; however, characteristics are by no means restricted thereto. All changes, alternations, or modifications conveniently considered by those skilled in the art are deemed to be encompassed within the scope of the present invention delineated by the following claims.

What is claimed is:

1. A three-dimensional positioning system comprising:
a communication module configured to receive optical image data of a target area from one or more optical imagers and radar image data of the target area from one or more radar imagers;
a processor in communication with the communication module;
a display in communication with the processor; and
computer readable storage media in communication with the processor and configured to induce the processor to
(A) receive optical image data of the target area from the one or more optical imagers and to generate a plurality of corresponding optical images;
(B) employ direct geo-referencing to establish a first geometric model of the plurality of optical images;
(C) receive radar image data of the target area from the one or more radar imagers to generate a plurality of corresponding radar images;
(D) determine range data from the plurality of radar images and employ the range data and a Doppler equation to establish a second geometric model of the radar images;
(E) back project the plurality of optical images according to virtual ground control points in the first geometric model for the optical images;
(F) calculate optical image coordinates corresponding to the virtual ground control points using collinear conditions;
(G) back project the radar images according to the virtual ground control points in the second geometric model of the radar images;
(H) calculate radar image coordinates corresponding to the virtual ground control points with the range data and the Doppler equation;
(I) calculate rational polynomial coefficients for the optical images and for the radar images to establish an integrated rational function model;
(J) convert the optical and the radar image coordinates to a rational function space and calculate corresponding rational function space coordinates;
(K) obtain affine conversion coefficients from the rational function space coordinates and the optical and the radar image coordinates according to the ground control points;
(L) complete a linear conversion to correct system error;
(M) execute partial compensation via least squares collocation for amendments to eliminate systematic errors;
(N) measure conjugate points after the rational function model is established and refined from the optical images and from the radar images;
(O) place the conjugate points into the rational function model to establish an observation equation of three-dimensional positioning; and
(P) induce the display to display a position of a target within the target area as a three-dimensional spatial coordinate via a least squares method.

2. The system of claim 1, wherein at step (B), the processor establishes the optical image geometric model using a direct geographic counterpoint method with a mathematical formula of:
\vec{G}=\vec{P}+S\vec{U},
Xᵢ=X(tᵢ)+Sᵢuᵢ^{X}
Yᵢ=Y(tᵢ)+Sᵢuᵢ^{Y}
Zᵢ=Z(tᵢ)+Sᵢuᵢ^{Z},
wherein, \vec{G} is a vector from Earth's centroid to the ground surface; \vec{P} is a vector from Earth's centroid to a satellite; Xᵢ, Yᵢ, Zᵢ are respectively ground three-dimensional coordinates; X(tᵢ), Y(tᵢ), Z(tᵢ) are satellite orbital positions; uᵢ^{X}, uᵢ^{Y}, uᵢ^{Z} are respectively image observation vectors; Sᵢ is an amount of scale; and tᵢ is time.

3. The system of claim 1, wherein in step (D), the second geometric model of the radar images based on the range data and the Doppler equation has the mathematical formula of:
$$\vec{R} = \vec{G} - \vec{P} , \\ \vert \vec{R} \vert = \vert \vec{G} - \vec{P} \vert , \\ {f}_{d} = - \frac{2}{λ} \frac{d \vec{R}}{d t} ,$$
wherein \vec{R} is a vector from a satellite to a ground point; \vec{G} is a vector from Earth's centroid to the ground point of the vector; and \vec{P} is a vector from Earth's centroid to the satellite.

4. The system of claim 1, wherein the rational function model at step (I) is obtained by getting rational polynomial coefficients according to a plurality of virtual ground control points and a least squares method, based on the rational function model with a mathematical formula of:
$${S}_{RFM} = \frac{{p}_{a} ( X , Y , Z )}{{p}_{b} ( X , Y , Z )} = \frac{{\sum }_{i = 0}^{i = 3} {\sum }_{j = 0}^{j = 3} {\sum }_{k = 0}^{k = 3} {a}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {b}_{ijk} {X}^{i} {Y}^{j} {Z}^{k}}$$
$${L}_{RFM} = \frac{{p}_{c} ( X , Y , Z )}{{p}_{d} ( X , Y , Z )} = \frac{{\sum }_{i = 0}^{i = 3} {\sum }_{j = 0}^{j = 3} {\sum }_{k = 0}^{k = 3} {c}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {d}_{ijk} {X}^{i} {Y}^{j} {Z}^{k}} ,$$
wherein aᵢⱼₖ, bᵢⱼₖ, cᵢⱼₖ and dᵢⱼₖ are respectively rational function coefficients.

5. The system of claim 1, wherein at step (K), the rational function model is refined by correcting the rational function model via affine transformation with a mathematical formula of:
Ŝ=A₀×S_{RFM}+A₁×L_{RFM}+A₂
\hat{L}=A₃×S_{RFM}+A₄×L_{RFM}+A₅
wherein Ŝ and \hat{L} are respectively corrected image coordinates and A_{0˜5} are affine conversion coefficients.

6. The system of claim 1, wherein at step (O), the observation equation of the three-dimensional positioning has a mathematical formula of:
$$[ \begin{matrix}{υ}_{S}^{1} \\ {υ}_{L}^{1} \\ {υ}_{S}^{2} \\ {υ}_{L}^{2}\end{matrix} ] = [ \begin{matrix}\frac{\partial {S}_{1}}{\partial X} & \frac{\partial {S}_{1}}{\partial Y} & \frac{\partial {S}_{1}}{\partial Z} \\ \frac{\partial {L}_{1}}{\partial X} & \frac{\partial {L}_{1}}{\partial Y} & \frac{\partial {L}_{1}}{\partial Z} \\ \frac{\partial {S}_{2}}{\partial X} & \frac{\partial {S}_{2}}{\partial Y} & \frac{\partial {S}_{2}}{\partial Z} \\ \frac{\partial {L}_{2}}{\partial X} & \frac{\partial {L}_{2}}{\partial Y} & \frac{\partial {L}_{2}}{\partial Z}\end{matrix} ] [ \begin{matrix}dX \\ dY \\ dZ\end{matrix} ] + [ \begin{matrix}{\hat{S}}_{1} - {S}_{1} \\ {\hat{L}}_{1} - {L}_{1} \\ {\hat{S}}_{2} - {S}_{2} \\ {\hat{L}}_{2} - {L}_{2}\end{matrix} ] .$$

7. The system of claim 1, wherein in step (C), the plurality of radar images is of synthetic aperture radar images.

8. The system of claim 1, wherein the one or more optical imagers and the one or more radar imagers each comprise a plurality of different types of imagers.

9. The system of claim 8, wherein the plurality of radar imagers comprises a ALOS/PALSAR satellite-based imager and a COSMO-SkyMed satellite-based imager and wherein the plurality of optical imagers comprises a ALOS/PRISM optical satellite-based imager, a SPOT-5 panchromatic optical satellite-based imager, and a SPOT-5 Super mode optical satellite-based imager.

10. Computer readable storage media configured to induce a processor and associated display to
(A) receive optical image data of a target area from one or more optical imagers and to generate a plurality of corresponding optical images;
(B) employ direct geo-referencing to establish a first geometric model of the plurality of optical images;
(C) receive radar image data of the target area from one or more radar imagers to generate a plurality of corresponding radar images;
(D) determine range data from the plurality of radar images and employ the range data and a Doppler equation to establish a second geometric model of the radar images;
(E) back project the plurality of optical images according to virtual ground control points in the first geometric model for the optical images;
(F) calculate optical image coordinates corresponding to the virtual ground control points using collinear conditions;
(G) back project the radar images according to the virtual ground control points in the second geometric model of the radar images;
(H) calculate radar image coordinates corresponding to the virtual ground control points with the range data and the Doppler equation;
(I) calculate rational polynomial coefficients for the optical images and for the radar images to establish an integrated rational function model;
(J) convert the optical and the radar image coordinates to a rational function space and calculate corresponding rational function space coordinates;
(K) obtain affine conversion coefficients from the rational function space coordinates and the optical and the radar image coordinates according to the ground control points;
(L) complete a linear conversion to correct system error;
(M) execute partial compensation via least squares collocation for amendments to eliminate systematic errors;
(N) measure conjugate points after the rational function model is established and refined from the optical images and from the radar images;
(O) place the conjugate points into the rational function model to establish an observation equation of three-dimensional positioning; and
(P) display a position of a target within the target area as a three-dimensional spatial coordinate via a least squares method.

11. The computer readable storage media of claim 10, wherein at step (B), the optical image geometric model is established using a direct geographic counterpoint method with a mathematical formula of:
\vec{G}=\vec{P}+S\vec{U},
Xᵢ=X(tᵢ)+Sᵢuᵢ^{X}
Yᵢ=Y(tᵢ)+Sᵢuᵢ^{Y}
Zᵢ=Z(tᵢ)+Sᵢuᵢ^{Z},
wherein, \vec{G} is a vector from Earth's centroid to the ground surface; \vec{P} is a vector from Earth's centroid to a satellite; Xᵢ, Yᵢ, Zᵢ are respectively ground three-dimensional coordinates; X(tᵢ), Y(tᵢ), Z(tᵢ) are satellite orbital positions; uᵢ^{X}, uᵢ^{Y}, uᵢ^{Z} are respectively image observation vectors; Sᵢ is an amount of scale; and tᵢ is time.

12. The computer readable storage media of claim 10, wherein in step (D), the second geometric model of the radar images based on the range data and the Doppler equation has the mathematical formula of:
$$\vec{R} = \vec{G} - \vec{P} , \\ \vert \vec{R} \vert = \vert \vec{G} - \vec{P} \vert , \\ {f}_{d} = - \frac{2}{λ} \frac{d \vec{R}}{d t} ,$$
wherein \vec{R} is a vector from a satellite to a ground point; \vec{G} is a vector from Earth's centroid to the ground point of the vector; and \vec{P} is a vector from Earth's centroid to the satellite.

13. The computer readable storage media of claim 10, wherein the rational function model at step (I) is obtained by getting rational polynomial coefficients according to a plurality of virtual ground control points and a least squares method, based on the rational function model with a mathematical formula of:
$${S}_{RFM} = \frac{{p}_{a} ( X , Y , Z )}{{p}_{b} ( X , Y , Z )} = \frac{{\sum }_{i = 0}^{i = 3} {\sum }_{j = 0}^{j = 3} {\sum }_{k = 0}^{k = 3} {a}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {b}_{ijk} {X}^{i} {Y}^{j} {Z}^{k}}$$
$${L}_{RFM} = \frac{{p}_{c} ( X , Y , Z )}{{p}_{d} ( X , Y , Z )} = \frac{{\sum }_{i = 0}^{i = 3} {\sum }_{j = 0}^{j = 3} {\sum }_{k = 0}^{k = 3} {c}_{ijk} {X}^{i} {Y}^{j} {Z}^{k}}{{\sum }_{i = 0}^{i = 3} {\sum }_{j = 0}^{j = 3} {\sum }_{k = 0}^{k = 3} {d}_{ijk} {X}^{i} {Y}^{j} {Z}^{k}} ,$$
wherein aᵢⱼₖ, bᵢⱼₖ, cᵢⱼₖ and dᵢⱼₖ are respectively rational function coefficients.

14. The computer readable storage media of claim 10, wherein at step (K), the rational function model is refined by correcting the rational function model via affine transformation with a mathematical formula of:
Ŝ=A₀×S_{RFM}+A₁×L_{RFM}+A₂
\hat{L}=A₃×S_{RFM}+A₄×L_{RFM}+A₅
wherein Ŝ and \hat{L} are respectively corrected image coordinates and A_{0˜5} are affine conversion coefficients.

15. The computer readable storage media of claim 10, wherein at step (O), the observation equation of the three-dimensional positioning has a mathematical formula of:
$$[ \begin{matrix}{υ}_{S}^{1} \\ {υ}_{L}^{1} \\ {υ}_{S}^{2} \\ {υ}_{L}^{2}\end{matrix} ] = [ \begin{matrix}\frac{\partial {S}_{1}}{\partial X} & \frac{\partial {S}_{1}}{\partial Y} & \frac{\partial {S}_{1}}{\partial Z} \\ \frac{\partial {L}_{1}}{\partial X} & \frac{\partial {L}_{1}}{\partial Y} & \frac{\partial {L}_{1}}{\partial Z} \\ \frac{\partial {S}_{2}}{\partial X} & \frac{\partial {S}_{2}}{\partial Y} & \frac{\partial {S}_{2}}{\partial Z} \\ \frac{\partial {L}_{2}}{\partial X} & \frac{\partial {L}_{2}}{\partial Y} & \frac{\partial {L}_{2}}{\partial Z}\end{matrix} ] [ \begin{matrix}dX \\ dY \\ dZ\end{matrix} ] + [ \begin{matrix}{\hat{S}}_{1} - {S}_{1} \\ {\hat{L}}_{1} - {L}_{1} \\ {\hat{S}}_{2} - {S}_{2} \\ {\hat{L}}_{2} - {L}_{2}\end{matrix} ] .$$

16. The computer readable storage media of claim 10, wherein in step (C), the plurality of radar images is of synthetic aperture radar images.

17. The computer readable storage media of claim 10, wherein the one or more optical imagers and the one or more radar imagers each comprise a plurality of different types of imagers.

18. The system of claim 17, wherein the plurality of radar imagers comprises a ALOS/PALSAR satellite-based imager and a COSMO-SkyMed satellite-based imager and wherein the plurality of optical imagers comprises a ALOS/PRISM optical satellite-based imager, a SPOT-5 panchromatic optical satellite-based imager, and a SPOT-5 Super mode optical satellite-based imager.
